(19) United States
(12) Patent Application Publication
(10) Pub. No.: US 2013/0060628 A1
(43) Pub. Date: Mar. 7, 2013

(54) Online digital-advertising agency and media-buying method and system

(71) Applicant: Eugene Catrambone, Westlake Village, CA (US)

(72) Inventor: Eugene Catrambone, Westlake Village, CA (US)

(21) Appl. No.: 13/507,743

(22) Filed: Jul. 24, 2012

Related U.S. Application Data
(60) Provisional application No. 61/572,889, filed on Jul. 25, 2011.

(51) Int. Cl. G06Q 30/02

(52) U.S. Cl. 705/14.41

(57) ABSTRACT

A system and method for promoting commercial-media advertising and generating advertising revenue on the Internet is disclosed that enables creators of digital-media content to buy and sell media content and exhibition time directly through an online electronic marketplace. The system and method provide a platform allowing commercial advertising media buyers to both bid for and buy exhibition time directly from exhibition sellers who exhibit their videos on the Internet; and provides digital-video exhibition sellers the platform to both offer for sale and sell exhibition time directly to bidding advertising media buyers. The Invention recognizes that digital-video content creators can and do exhibit their own video content on a multitude of sites on the Internet, and in that respect, have the potential to attach a commercial element to their video content and receive monetary compensation from commercial sponsors for the product's exhibition.

### FIELD OF THE INVENTION

The invention relates generally to promoting ecommerce through online commercial media advertising and particularly to creating a more competitive marketplace by introducing a system and method in which to create and exchange media content for exhibition, promotion and monetary compensation.

### BACKGROUND OF THE INVENTION

Traditionally, Media Buyers are the individuals responsible for purchasing time and advertising space for the purpose of advertising, and as such, act on behalf of the advertising Sponsor When planning what to buy, they must evaluate factors based on exhibition formats, pricing rates, demographics, and other factors relating to the advertiser's particular product or service objectives. They negotiate rates and create media schedules based on a media plan. Media Buyers can pick and choose what and/or which combination of media is most appropriate and effective to achieve their goal, whether it is to make a sale, and/or to deliver a message or idea. An Advertising Agency is a service business dedicated to creating, planning and handling advertising and promotion for its clients. An ad agency is independent from the client and provides an outside point of view to the effort of selling the client's products or services. Agencies may be hired to produce commercial content as part of an advertising campaign. The Internet offers a number of online media that has surfaced with the improvement of technology and the accessibility of the Internet. Online media can include social media, emails, search engines and referral links, web portals, banners, interactive games, and video clips.

With the introduction of the Invention, the role and function of both the Media Buyer and Advertising Agency are extended to include and enable digital-media content producer/creator/exhibitors to act, in effect, in the capacity of a traditional advertising agent by providing and selecting the media content and venue for online exhibition of the product containing the advertising sponsor's commercial element. Additionally, the producer/creator exhibitor can initiate the media buy by selecting a sponsor posting a bid price, typically referred as CPM rate (cost-per-1000-impressions), obligating to pay for an amount of viewing set by the sponsor in the posting.

The Invention includes a pricing method based on a bid/ask market that electronically allows the participants to select the price they are willing to pay or receive for exhibition of media product. The “bid” price is the price a Sponsor is willing to pay to the Exhibitor for displaying media content containing the Sponsor's commercial element. The Sponsor may have set a criterion against which information, supplied by the Exhibitor regarding his video content, must match, or, he may choose to make his commercial element available to any Exhibitor subject only to the number of CPM-based viewings he is will to buy and based on that rate. The Invention offers a novel way to interchange the traditional roles of Media Buyer, Advertising Sponsor and Exhibitor.

### SUMMARY OF THE INVENTION

The present invention represents a method and system for expanding the scope of online advertising by building an electronic ad agency and media-buy marketplace where all creators of digital-media files can connect with commercial advertisers willing to pay performance fees for the exhibition of content containing the commercial element provided by the sponsoring advertiser. The method and system provides a novel symmetrical two-way market platform allowing either party to make the selection and exhibit the media. For example, the creator of a music video, seeking to earn advertising income, selects from the system's inventory of sponsors, a sponsor willing to pay a stated rate-per-view for every viewing of his 10-second commercial video element. The music video producer then uploads his music video file to the host server containing the commercial media element provided by the advertising sponsor and the two media files are “merged” together into a “composite” video file. In accomplishing this, the music video creator can simply “drag-and-drop” the two media elements together inside the digital-video editor and a composite file is produced. The composite-file created by the music video producer then selects the destination location that will contain and/or host the composite file and transfers the composite file to the target location; information regarding the target-site location is provided by the music-video producer, through a system interface, enabling the composite file to be monitored and tracked by the system host. Information returned back to the host system then acts as the basis for subsequent pay-per-view calculations and every time the music video containing the commercial element is played the music-video creator's host-system account is credited and the advertising sponsor's host-system account is debited accordingly

In another example, the advertising sponsor will select a video “offered” by an exhibitor on the host system. The sponsor will then merge his commercial content with the exhibitor's video file and transfer the composite-video file to a target location for exhibition. In this case, the advertising sponsor will provide information regarding the target site and video-host location that will allow the composite file to be monitored and tracked by the system host. Pay-per-viewing will occur in the same fashion in which the exhibitor's host-system account is credited for each discrete public viewing while the Sponsor's host-system account is debited.

The Invention further comprises a computer-implemented bid/ask pricing function that automatically posts the prices users choose to buy and sell their content at. For example, the advertising sponsor may be willing to pay $0.03 per view to exhibitors who embed the advertising sponsor's commercial content. The sponsor would indicate the price by enabling a “bid” price quote which will appear on the inventory list of available sponsors seen by the exhibitor and provided by the system platform. The exhibitor, on the other hand, may indicate that he is willing to accept $0.01 per view from sponsors for exhibiting his content containing up to a 10-seconds of the sponsor's commercial element by enabling a “ask” price quote which will appear on the inventory list of available exhibitors as seen by the sponsor and provided by the system platform.

The present invention allows all forms of digital media, including text, graphics, sound, video and mixed media to be submitted by advertising sponsors for merging into the exhibitor's video file.

### BRIEF DESCRIPTION OF THE DRAWINGS

FIG. 1 is a drawing representing the System Host site receiving media files, i.e., video files online from the both the buyer (commercial sponsor) and seller (exhibitor). The Host Site organizes the media files based on the information provided by both buyer and seller (the Users) and creates a searchable inventory database accessible by the Users and an interface in which to market and exchange items. Prices are determined by the Users in which (1) the seller agrees to exhibit the buyer's commercial-media content at the buyer's bid price and/or (2) allow the buyer to effect the exhibition by accepting the seller's offer price.

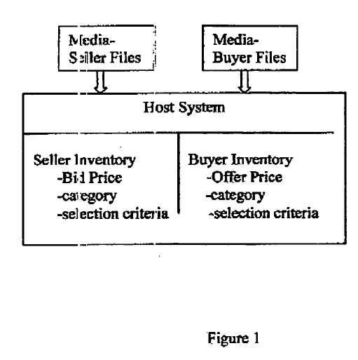

FIG. 2 is a drawing representing the media-editing function where the User will combine/edit/merge the two media elements together into a composite media file. The User selects the media elements from the inventory of the counterparty according to the information provided and for which is regulated by the System Host. The Host System provides the software platform in which to effect the editing and merging.

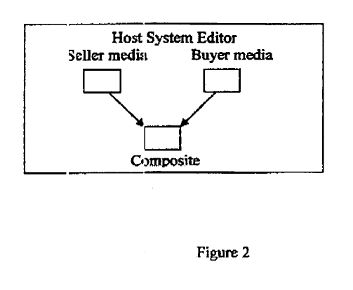

FIG. 3 is a drawing representing the subsequent upload/transfer of the composite media file to a location for exhibition of the media by the User. This location could be a single or multiple of sites including the Host System, websites or any Internet location, where the file will be viewed. The seller's media file (generally a self-created video file) effectively becomes the “venue” for the media buyer and the buyer's promotional media is viewed at any location offered for exhibitor by the seller. The Host System will also provide the media player and/or video hosting function for the composite file.

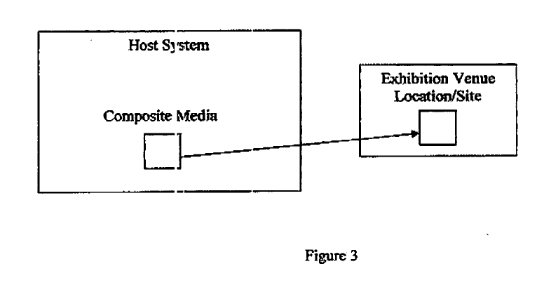

FIG. 4 is a drawing representing the Host System tracking/monitoring the performance/viewing of the composite video at the Venue site location. Tracking/monitoring information is provided to both buyer and seller and debits/credits the User accounts accordingly. The System Host collects a fee from the seller for facilitating the process and tracking the performance of the composite file.

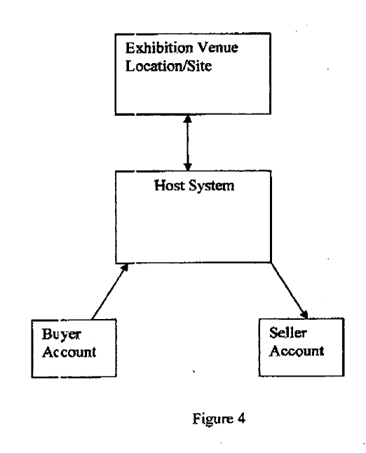

What I claim as my invention is:

1. A computer-implemented method and system for promoting commercial-media advertising and generating advertising revenue on the Internet by enabling online media-buying and exhibition-time selling in a user-accessible online environment comprising: a) receiving a plurality of digital-media files and placing digital-media content into an inventory database; b) receiving information on digital-media files; c) categorizing digital-media content; d) querying and selecting digital-media content; e) editing and merging digital-media content; f) transferring edited media product to target locations and media players; g) monitoring and tracking the performances of the merged product exhibited on target sites and media players; h) crediting and debiting payment to all parties for exhibition.

2. The method of claim 1(a) wherein receiving a plurality of digital-media files and placing digital-media file content into an inventory database comprises a system interface for receiving, transferring, downloading, uploading source digital-media content provide by the user and counterparty.

3. The method of claim 1(a), wherein receiving a plurality of digital-media files and placing digital-media file content into an inventory database comprises one or more of text, image, sound, video and mixed media.

4. The method of claim 1(b), wherein receiving information on digital-media files comprises: categorical, operational, pricing, limiting, and conditional information.

5. The method of claim 5, wherein receiving information on digital-media files comprises categorical, operational, pricing, limiting, and conditional information further comprises a computer system and interface for establishing and matching query items pertaining to the information-class selection criterion.

6. The method of claim 4, wherein receiving information on digital-media files comprises: categorical, operational, pricing, limiting, and conditional information further comprises a computer system for pricing online advertising, comprising: a pricing engine that displays “bid/ask” prices set and determined by the user; a means of setting and allocating media-buy amounts among a plurality of advertisement media exhibitions; a means of exhibiting a plurality of advertisement impressions/exhibitions on a relational basis to a plurality of exhibitors; and a means of sorting and selecting media content based on bid/ask price and content criteria.

7. The method of claim 1(e), wherein editing and merging digital-media content further comprises a computer system and interface for manipulating digital media and merging user media with counterparty media creating a combined media product.

8. The method of claim 1(f), wherein transferring edited media product to target locations and media players comprises providing an interface for transferring composite product to exhibiting locations and media players.

9. The method of claim 1(g), wherein monitoring and tracking the performances of the merged product exhibited on target sites and media players further comprises a computer system and interface tor tracking media performance whereby access and permission to the target sites is given to the system host/server by the user and which includes username and password information; querying performance statistics related to the users account on the target site and returning such information back to the system server monitoring, tracking and counting the exhibition performances on target sites and media players.

10. The method of claim 1(h), wherein crediting and debiting payment to all parties for exhibition further comprises a computer system and interface for automated banking transfers between system host master house account, user house sub-accounts, host bank account and user bank accounts facilitating the accounting and payment to and from all parties in the system.
